(19) United States
(12) Patent Application Publication
(10) Pub. No.: US 2024/0403159 A1
(43) Pub. Date: Dec. 5, 2024

(54) MONITORING APPARATUS, MONITORING METHOD, AND COMPUTER-READABLE STORAGE MEDIUM

(71) Applicant: NEC Corporation, Minato-ku, Tokyo (JP)

(72) Inventors: Io FURUYAMA, Tokyo (JP); Kazuaki Nakajima, Tokyo (JP); Hirofumi Ueda, Tokyo (JP)

(73) Assignee: NEC Corporation, Minato-ku, Tokyo (JP)

(21) Appl. No.: 18/699,951

(22) PCT Filed: Nov. 11, 2021
(86) PCT No.: PCT/JP2021/041479

§ 371 Date: Apr. 10, 2024

(51) Int. Cl. G06F 11/07; G06F 11/30

(52) U.S. Cl. CPC G06F 11/0793; G06F 11/0778; G06F 11/3051

(57) ABSTRACT

A monitoring apparatus according to an embodiment of the present disclosure is provided with: a storage unit that stores configuration information corresponding to each of a plurality of devices included in a system; a first identification unit that identifies configuration information corresponding to a first device among the plurality of devices for which an agent for collecting information has not been set; a second identification unit that identifies a second device, which is a device among the plurality of devices that corresponds to configuration information similar to the configuration information corresponding to the first device and for which the agent has been set; and an association unit that associates operational information of the second device, which includes information collected by the agent, with the first device.

### TECHNICAL FIELD

The present disclosure relates to a technology of managing a system using configuration information.

### BACKGROUND ART

When managing the system, devices included in the system are monitored. PTL 1 discloses a technology of managing a system that operates a plurality of virtual servers. In particular, PTL 1 discloses monitoring an operation state of a virtual server based on information collected from an agent set in the virtual server.

### CITATION LIST

### Patent Literature

PTL 1: JP 2016-051399 A

### SUMMARY OF INVENTION

### Technical Problem

Depending on the devices, there is a device for which an agent for collecting information as described above is not capable of being set due to a resource shortage of the device, an operating system (OS) of the device not related to the agent, or the like. The device for which the agent is not capable of being directly set has less information that can be collected than a device for which the agent can be set. Therefore, there is a concern that it is not possible to appropriately monitor the device for which the agent is not capable of being directly set.

PTL 1 does not disclose a monitoring method in a case where there is the device for which the agent is not capable of being set.

An objective of the present disclosure is to provide a monitoring apparatus and the like capable of assisting in monitoring devices in a system that includes a device for which an agent is not capable of being set.

### Solution to Problem

A monitoring apparatus according to one aspect of the present disclosure includes a storage means that stores configuration information related to each of a plurality of devices included in a system, a first identification means that identifies configuration information related to a first device for which an agent for collecting information is not set, among the plurality of devices, a second identification means that identifies a second device, which is a device related to configuration information similar to the configuration information related to the first device and for which the agent is set, among the plurality of devices, and an association means that associates operation information of the second device, which includes information collected by the agent, with the first device.

A monitoring method according to one aspect of the present disclosure stores configuration information related to each of a plurality of devices included in a system, identifies configuration information related to a first device for which an agent for collecting information is not set, among the plurality of devices, identifies a second device, which is a device related to configuration information similar to the configuration information related to the first device and for which the agent is set, among the plurality of devices, and associates operation information of the second device, which includes information collected by the agent, with the first device.

A computer-readable storage medium according to one aspect of the present disclosure stores a program for allowing a computer to execute processing of storing configuration information related to each of a plurality of devices included in a system, processing of identifying configuration information related to a first device for which an agent for collecting information is not set, among the plurality of devices, processing of identifying a second device, which is a device related to configuration information similar to the configuration information related to the first device and for which the agent is set, among the plurality of devices, and processing of associating operation information of the second device, which includes information collected by the agent, with the first device.

### Advantageous Effects of Invention

According to the present disclosure, it is possible to assist in monitoring the devices in the system that includes the device for which the agent is not capable of being set.

### BRIEF DESCRIPTION OF DRAWINGS

FIG. 1 is a diagram schematically illustrating an example of a configuration including a monitoring apparatus according to a first example embodiment of the present disclosure.

FIG. 2 is a block diagram illustrating an example of a functional configuration of the monitoring apparatus according to the first example embodiment of the present disclosure.

FIG. 3 is a flowchart illustrating an example of an operation of the monitoring apparatus according to the first example embodiment of the present disclosure.

FIG. 4 is a diagram schematically illustrating an example of a configuration including a monitoring apparatus according to a second example embodiment of the present disclosure.

FIG. 5 is a block diagram illustrating an example of a functional configuration of the monitoring apparatus according to the second example embodiment of the present disclosure.

FIG. 6 is a diagram illustrating an example of a relationship of configuration information according to the second example embodiment of the present disclosure.

FIG. 7 is a flowchart illustrating an example of an operation of the monitoring apparatus according to the second example embodiment of the present disclosure.

FIG. 8 is a flowchart illustrating another example of the operation of the monitoring apparatus according to the second example embodiment of the present disclosure.

FIG. 9 is a diagram schematically illustrating an example of a configuration including a monitoring apparatus according to a third example embodiment of the present disclosure.

FIG. 10 is a block diagram illustrating an example of a functional configuration of the monitoring apparatus according to the third example embodiment of the present disclosure.

FIG. 11 is a flowchart illustrating an example of an operation of the monitoring apparatus according to the third example embodiment of the present disclosure.

FIG. 12 is a flowchart illustrating an example of an operation of a monitoring apparatus according to Modification Example 4 of the present disclosure.

FIG. 13 is a block diagram illustrating an example of a functional configuration of a monitoring apparatus according to Modification Example 5 of the present disclosure.

FIG. 14 is a block diagram illustrating an example of a hardware configuration of a computer device that enables the monitoring apparatus according to the first, second, third, and fourth example embodiments of the present disclosure.

### EXAMPLE EMBODIMENT

Hereinafter, example embodiments of the present disclosure will be described with reference to the drawings.

### First Example Embodiment

The outline of a monitoring apparatus of the present disclosure will be described.

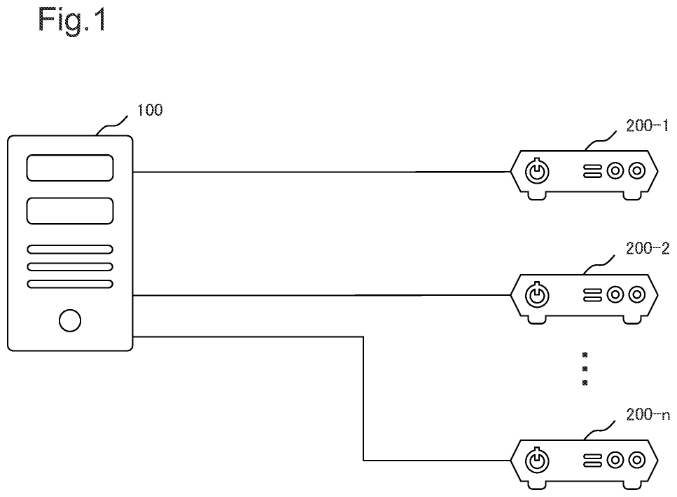

FIG. 1 is a diagram schematically illustrating an example of a configuration including a monitoring apparatus 100. As illustrated in FIG. 1, the monitoring apparatus 100 is connected to communication devices 200-1, 200-2, . . . , and 200-n (n is a natural number of 1 or more) via a wireless or wired network such that communication is available. The monitoring apparatus 100 may be further connected to a terminal (not illustrated) of a user who manages the monitoring apparatus 100 such that communication is available. Here, in a case where the communication devices 200-1, 200-2, . . . , and 200-n are not distinguished from one another, the communication devices will be simply referred to as a communication device 200. The communication device 200 may be further connected to another communication device 200 such that communication is available to construct a network. Each of the communication devices 200 is not limited to the same device.

The monitoring apparatus 100 manages a system including the communication device 200. The system including the communication device 200 is a system that provides a service via a network. The communication device 200 is a device constituting the system. The communication device 200 includes a network device, a server device, a storage device, and the like. The system including the communication device 200 may be, for example, a system that constructs an in-house network of a company, or a system that controls a machine tool, a sensor, or the like used in a factory. The system including the communication device 200 may be a system that constructs a network of communication lines. In the case of constructing the network of the communication lines, the communication device 200 may be, for example, a device having the function of a base station, a core, a switch, and the like, including a radio unit (RU), a distributed unit (DU), a central unit (CU), and the like.

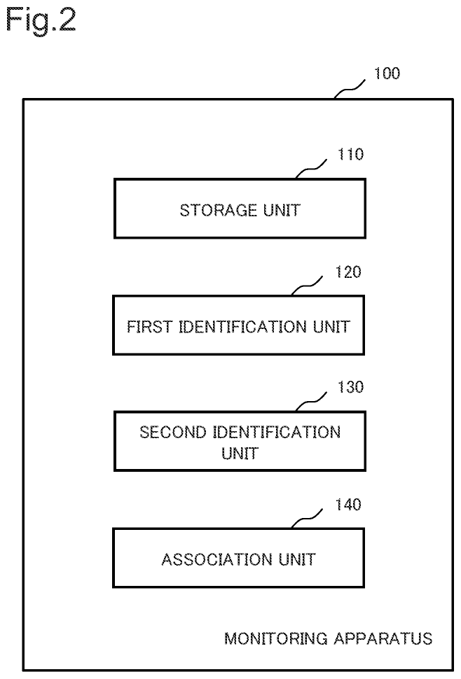

FIG. 2 is a block diagram illustrating an example of a functional configuration of the monitoring apparatus 100 according to the first example embodiment. As illustrated in FIG. 2, the monitoring apparatus 100 includes a storage unit 110, a first identification unit 120, a second identification unit 130, and an association unit 140.

The storage unit 110 stores configuration information. The configuration information is information indicating the configuration of the communication device 200 included in the system. For example, the configuration information of the communication device 200 includes information set in the communication device 200, information of electronic components mounted on the communication device 200, information of software installed in the communication device 200, and the like. The configuration information may include information indicating whether an agent is set in the related communication device 200. The storage unit 110 stores configuration information related to each of the communication devices 200. At this time, the storage unit 110 may store the configuration information, for example, by the input of a user who operates the monitoring apparatus 100. In this manner, the storage unit 110 stores configuration information related to each of a plurality of devices included in the system. The storage unit 110 is an example of a storage means.

The first identification unit 120 identifies a device for which an agent is not set, among the plurality of communication devices 200 included in the system. The agent is a software module that collects various types of information from target devices. The agent may also perform other operations. The agent may also be referred to as an agent program or a software agent. Here, the device for which the agent is not set is, for example, a device for which an agent is not introduced and information is not collected by the agent. The device for which the agent is not set is not limited to this example. For example, an agent set on a server may acquire information on a device that may communicate with the server. Such a device for which an agent is not directly set and information is indirectly collected by the agent may also be included in the “device for which the agent is not set” in the present disclosure. In the present disclosure, the device for which the agent is not set is also referred to as a first device. Then, the first identification unit 120 identifies configuration information related to the first device.

In this manner, the first identification unit 120 identifies the configuration information related to the first device for which an agent for collecting information is not set, among the plurality of devices. The first identification unit 120 is an example of a first identification means.

The second identification unit 130 identifies a device similar to the first device by using the configuration information related to the identified first device. The device similar to the first device is a device having a configuration similar to the configuration of the first device. The second identification unit 130 identifies, for example, a device similar to the configuration of the first device based on the configuration information. For example, the second identification unit 130 compares the configuration information related to the first device identified by the first identification unit 120 with the configuration information stored by the storage unit 110. At this time, a target to be compared with the configuration information related to the first device is, for example, configuration information of the device for which the agent is set. Then, for example, as a result of the comparison, the second identification unit 130 identifies a device related to configuration information similar to the configuration information related to the first device. The similar configuration information may be configuration information matching up with the configuration information related to the first device, or may be configuration information including information common to the configuration information related to the first device. In the present disclosure, a device related to the configuration information similar to the configuration information related to the first device, for which an agent is set, is also referred to as a second device. As described above, the second identification unit 130 identifies the second device, which is a device related to the configuration information similar to the configuration information related to the first device and for which the agent is set, among the plurality of devices. The second identification unit 130 is an example of a second identification means.

The association unit 140 associates predetermined operation information with the first device. The operation information includes, for example, log information of the communication device 200, statistical information relevant to various processing pieces of the communication device 200, various inspection results, and the like. For example, it is also possible to detect that an anomaly has occurred in the communication device 200 by using the information included in the operation information. The operation information includes the information collected by the agent, but may include other information. For example, the association unit 140 associates operation information related to the second device with the first device. Here, associating processing may be, for example, processing of setting a link that is accessible to the operation information related to the second device in the information relevant to the first device. The information relevant to the first device may be information for identifying the first device, the configuration information related to the first device, or the like. The associating processing may be processing of copying the operation information related to the second device and including the copied operation information in the information relevant to the first device. Accordingly, it is possible to refer to the operation information of the second device similar to the first device when monitoring the first device. As described above, the association unit 140 associates the operation information of the second device including the information collected by the agent with the first device. The association unit 140 is an example of an association means.

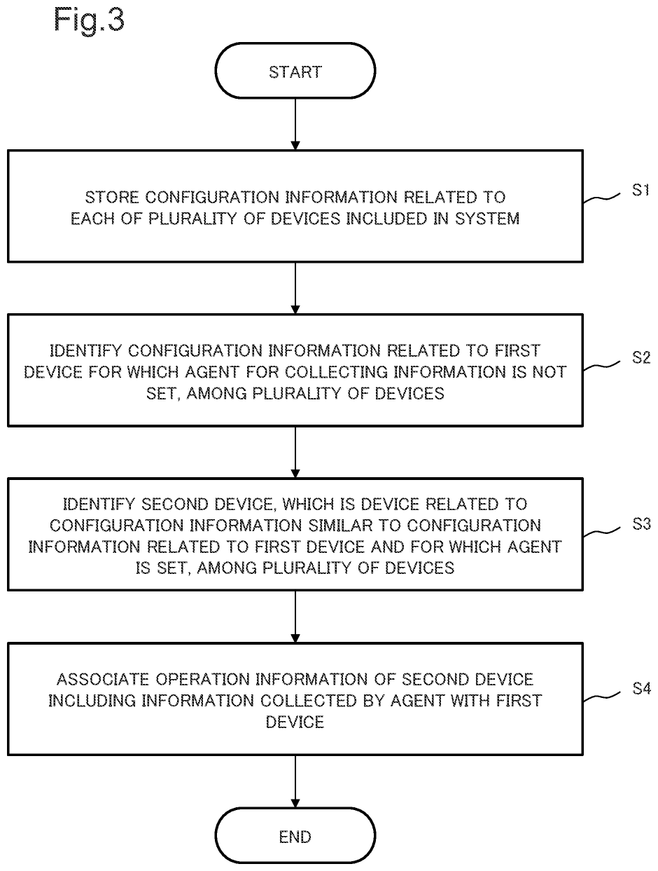

Next, an example of the operation of the monitoring apparatus 100 will be described with reference to FIG. 3. In the present disclosure, each step in the flowchart is represented using a number assigned to each step, such as “S1”.

FIG. 3 is a flowchart illustrating an example of the operation of the monitoring apparatus 100. The storage unit 110 stores the configuration information related to each of the plurality of devices included in the system (S1). The first identification unit 120 identifies the configuration information related to the first device for which the agent for collecting information is not set, among the plurality of devices (S2). The second identification unit 130 identifies the second device, which is a device related to the configuration information similar to the configuration information related to the first device and for which the agent is set, among the plurality of devices (S3). The association unit 140 associates the operation information of the second device including the information collected by the agent with the first device (S4).

As described above, the monitoring apparatus 100 of the first example embodiment stores the configuration information related to each of the plurality of devices included in the system, and identifies the configuration information related to the first device for which the agent for collecting information is not set, among the plurality of devices. Then, the monitoring apparatus 100 identifies the second device, which is a device related to the configuration information similar to the configuration information related to the first device and for which the agent is set, among the plurality of devices, and associates the operation information of the second device including the information collected by the agent with the first device.

The device for which the agent is not set has less information that can be collected than the device for which the agent is set. On the other hand, the monitoring apparatus 100 may associate operation information of devices having similar configuration information, for which an agent is set, with the device for which the agent is not set. The devices with the similar configuration information may perform the same operation or cause similar anomalies. Therefore, the monitoring apparatus 100 may monitor even the device for which the agent is not set with reference to the similar operation information of the devices. That is, the monitoring apparatus 100 according to the first example embodiment is capable of assisting in monitoring the devices in the system that includes the devices for which the agent is not capable of being set.

### Second Example Embodiment

Next, a monitoring apparatus according to a second example embodiment will be described. In the second example embodiment, the monitoring apparatus 100 described in the first example embodiment will be described in more detail.

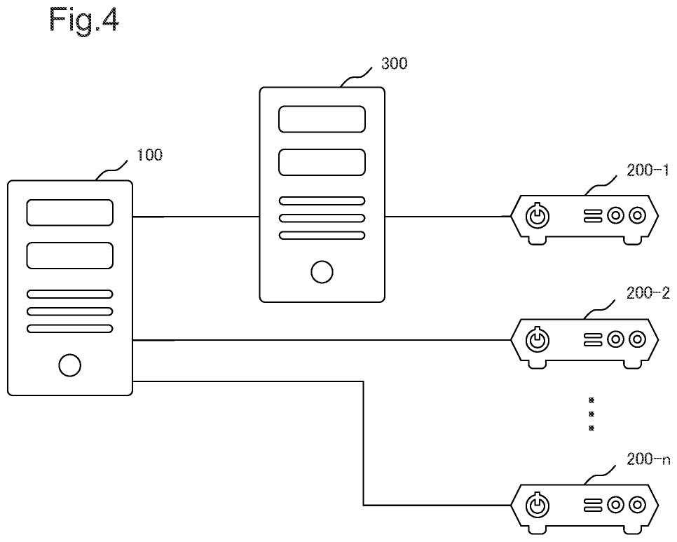

FIG. 4 is a diagram schematically illustrating an example of a configuration including the monitoring apparatus 100. The monitoring apparatus 100 is connected to each of the communication devices 200 such that communication is available. As illustrated in FIG. 4, the communication device 200-1 is connected to the monitoring apparatus 100 via a conversion server 300.

Here, in the present example embodiment, it is assumed that the communication device 200-1 is a device for which an agent is not set, and the communication devices 200-2, . . . , and 200-n are devices for which an agent is set. An agent is set in the conversion server 300. Then, the conversion server 300 collects information from the communication device 200-1, converts the collected information into an appropriate format, and transmits the converted information to the monitoring apparatus 100. Each of the communication devices 200-2, . . . , and 200-n transmits information collected by the set agent to the monitoring apparatus 100. At this time, the information collected from the communication device 200-1 for which the agent is not directly set is less than the information collected from the communication devices 200-2, n for which the agent is set. In a case where the amount of information is small, for example, there is a concern that an anomaly that has occurred in the communication device 200-1 is not capable of being appropriately detected. That is, it can be said that the communication device 200-1 has a lower monitoring level than the communication devices 200-2, . . . , n.

### [Details of Monitoring Apparatus 100]

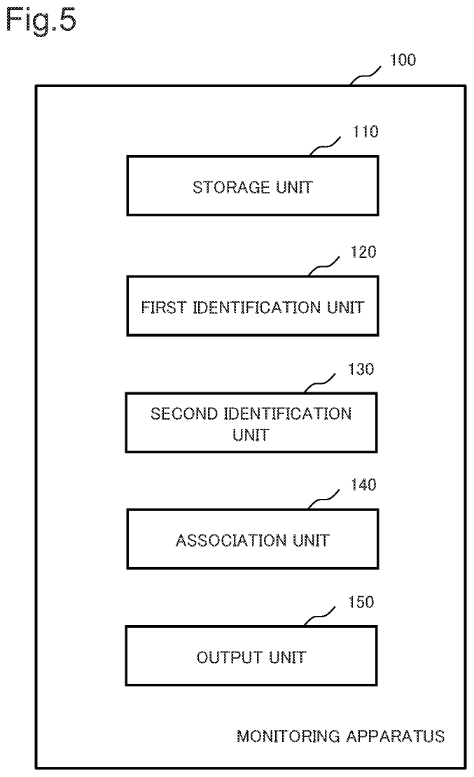

FIG. 5 is a block diagram illustrating an example of a functional configuration of the monitoring apparatus 100 according to the second example embodiment. As illustrated in FIG. 5, the monitoring apparatus 100 includes the storage unit 110, the first identification unit 120, the second identification unit 130, and the association unit 140, as in the first example embodiment. The monitoring apparatus 100 may include an output unit 150.

The storage unit 110 stores the system and the configuration information related to the communication device 200 included in the system. The configuration information includes, for example, system configuration information, device configuration information, model configuration information, and software configuration information. The system configuration information is information indicating the configuration of the system. For example, the system configuration information includes information indicating each of the communication devices 200 included in the system. The device configuration information is information uniquely created for each of the communication devices 200. The device configuration information indicates information set in the communication device 200. For example, the device configuration information may include information such as an address set in the device. The storage unit 110 stores device configuration information related to each of the communication devices 200.

The model configuration information is information relevant to an element mounted on the communication device 200. The element is, for example, an electronic component such as a CPU and a memory, software, and the like. That is, the model configuration information includes, for example, information relevant to an electronic component mounted on the communication device 200 and information indicating software installed in the communication device 200. Not limited to this, the model configuration information may include information such as a model number and a serial number of the communication device. The model configuration information may be information created for each production lot of the device. That is, the model configuration information related to the communication devices 200 produced in the same production lot may be the same. The storage unit 110 stores model configuration information related to each of the communication devices 200.

The software configuration information is information indicating the configuration of the software. Hereinafter, the software configuration information is also referred to as SW configuration information. The SW configuration information may be information created for each version of the software. The SW configuration information is, for example, a software bill of materials (SBOM). The SW configuration information may include authenticity information and vulnerability information of the software. The storage unit 110 stores SW configuration information related to each piece of software included in the communication device 200.

The device configuration information and the model configuration information are configuration information relevant to hardware. The SW configuration information is configuration information relevant to software. In this manner, the storage unit 110 stores the configuration information relevant to the hardware of each of the plurality of devices and the configuration information relevant to the software.

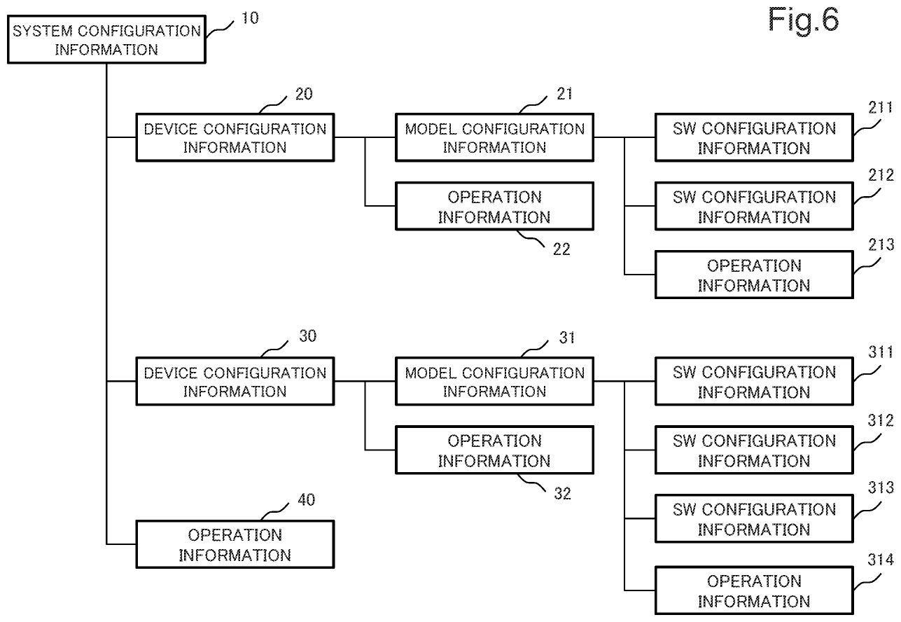

Here, the storage unit 110 may store the related configuration information pieces in association with each other. Processing of associating the configuration information is, for example, processing of including information that is accessible to the related configuration information in the configuration information. FIG. 6 is a diagram illustrating an example of a relationship of the configuration information stored in the storage unit 110. For example, it is assumed that the communication device 200-1 and the communication device 200-2 are included in the system. In this case, system configuration information 10 is associated with device configuration information 20 related to the communication device 200-1 and device configuration information 30 related to the communication device 200-2. The device configuration information 20 is associated with model configuration information 21 related to the communication device 200-1. Then, the model configuration information 21 is associated with SW configuration information pieces 211 and 212 related to each software installed in the communication device 200-1. Similarly, the device configuration information 30 is associated with model configuration information 31 related to the communication device 200-2. Then, the model configuration information 31 is associated with SW configuration information pieces 311, 312, and 313 related to each piece of software installed in the communication device 200-2. In this manner, the storage unit 110 stores the configuration information relevant to the hardware and the configuration information relevant to the software, which are related to the same device among the plurality of devices, in association with each other.

The storage unit 110 stores the operation information related to each of the communication devices 200. Specifically, the storage unit 110 acquires the information collected from the agent and stores the information as the operation information related to each of the communication devices 200. At this time, operation information relevant to hardware and operation information relevant to software may be separately stored. As illustrated in FIG. 6, the storage unit 110 may further store the operation information in association with each piece of configuration information. In the example of FIG. 6, operation information 40 is associated with the device configuration information pieces 20 and 30, operation information 22 is associated with the model configuration information 21, and operation information 213 is associated with the SW configuration information pieces 211 and 212. Each piece of operation information includes log information, statistical information, and the like, relevant to each piece of configuration information. For example, the operation information 22 may include the operation information relevant to the hardware including a temperature, a voltage, a displacement in a rotational speed of a fan, a usage rate of a CPU and a memory, various inspection results with respect to the hardware, and the like of a device related to the model configuration information 21. For example, the operation information 213 may include an operation log, an update history, and the like, relevant to the software related to each of the SW configuration information pieces 211 and 212.

The first identification unit 120 identifies the first device that is a device for which an agent is not set. For example, the first identification unit 120 may identify a device for which an agent is not set based on the SW configuration information. For example, the first identification unit 120 may identify a device designated by input from a terminal operated by the user, as the first device. Then, the first identification unit 120 identifies the configuration information of the first device from the configuration information stored by the storage unit 110. At this time, the first identification means may identify the configuration information relevant to the hardware related to the first device and the configuration information relevant to the software related to the first device.

The second identification unit 130 identifies configuration information similar to the configuration information identified by the first identification unit 120. Specifically, the second identification unit 130 compares the configuration information related to the first device with each piece of the configuration information stored in the storage unit 110. For example, the second identification unit 130 compares the configuration information relevant to the hardware of the first device with each piece of the configuration information relevant to the hardware stored in the storage unit 110. For example, the second identification unit 130 compares the configuration information relevant to the software of the first device with each piece of the configuration information relevant to the software stored in the storage unit 110. As a result of the comparison, the second identification unit 130 identifies a device related to the configuration information similar to the configuration information related to the first device.

At this time, the device related to the configuration information similar to the configuration information relevant to the hardware related to the first device and the device related to the configuration information similar to the configuration information relevant to the software related to the first device may be different devices. For example, the configuration information relevant to the hardware of the communication device 200-1 is similar to the configuration information relevant to the hardware of the communication device 200-2, and the configuration information relevant to the software of the communication device 200-1 is similar to the configuration information relevant to the software of the communication device 200-3. In this case, the second identification unit 130 identifies each of the communication device 200-2 and the communication device 200-3 as the second device for the communication device 200-1. As described above, the second identification unit 130 identifies, as the second device, the device related to the configuration information similar to the configuration information relevant to the hardware related to the first device and the device related to the configuration information similar to the configuration information relevant to the software related to the first device.

A method for determining the similarity is not limited to a specific method. For example, when specific information is common to the configuration information of the first device and the configuration information stored in the storage unit 110, the second identification unit 130 may determine that the configuration information of the first device and the configuration information stored in the storage unit 110 are similar to each other. In this case, for example, when the device model number is common between the configuration information of the first device and the configuration information stored in the storage unit 110, the second identification unit 130 may determine that the configuration information of the first device and the configuration information stored in the storage unit 110 are similar to each other. For example, in a case where the version of the software is common between the configuration information of the first device and the configuration information stored in the storage unit 110, the second identification unit 130 may determine that the configuration information of the first device and the configuration information stored in the storage unit 110 are similar to each other.

The second identification unit 130 may determine the similarity by calculating a similarity between the configuration information of the first device and each piece of the configuration information stored in the storage unit 110. For example, the second identification unit 130 may determine whether to match up with each item of the configuration information, and calculate a value according to the number of matched items, such as a ratio of matched items, as the similarity. Then, the second identification unit 130 may determine that the configuration information having the similarity equal to or more than the threshold value is similar to the configuration information of the first device. A method for calculating the similarity is not limited to this example. As described above, the second identification unit 130 may identify the device related to the configuration information in which the similarity according to the number of items common to the configuration information related to the first device and the stored configuration information is equal to or more than the threshold value.

The association unit 140 associates the operation information related to the second device with the first device. More specifically, the association unit 140 associates each of the operation information relevant to the hardware and the operation information relevant to the software related to the second device with the first device. The association unit 140 may associate any one of the operation information relevant to the hardware and the operation information relevant to the software related to the second device with the first device. For example, the configuration information relevant to the hardware of the communication device 200-1 is similar to the configuration information relevant to the hardware of the communication device 200-2, and the configuration information relevant to the software of the communication device 200-1 is similar to the configuration information relevant to the software of the communication device 200-3. In this case, the association unit 140 associates the operation information relevant to the hardware of the communication device 200-2 with the communication device 200-1. The association unit 140 associates the operation information relevant to the software of the communication device 200-3 with the communication device 200-1. As described above, the association unit 140 may associate the operation information relevant to the hardware of the device related to the configuration information similar to the configuration information relevant to the hardware related to the first device with the first device. The association unit 140 may associate the operation information relevant to the software of the device related to the configuration information similar to the configuration information relevant to the software related to the first device with the first device.

The output unit 150 outputs various types of information. For example, when outputting the information relevant to the first device, the output unit 150 outputs the information relevant to the second device. The output unit 150 displays, for example, various types of information on a display device. Here, the display device may be, for example, a display included in the terminal operated by the user who manages the system. The terminal may be a personal computer, or may be a portable terminal such as a smart phone or a tablet terminal. The present invention is not limited to this example, and the output unit 150 may output various types of information by a voice.

The output unit 150 may output various types of information according to the operation of the user. For example, it is assumed that a predetermined communication device 200 is designated by the operation of the user and a request for outputting the operation information is made. In this case, for example, the output unit 150 displays the operation information of the predetermined communication device 200 on the display device. Here, when the first device is designated and the request for outputting the operation information is made, the output unit 150 displays the operation information of the second device associated with the first device, together with the operation information of the first device. For example, it is assumed that a request for outputting the operation information of the communication device 200-1 is made. At this time, the output unit 150 displays operation information of another device associated with the communication device 200-1, together with the operation information of the communication device 200-1. As described above, when receiving a request for outputting the operation information of the first device, the output unit 150 outputs the operation information of the second device associated with the first device. The output unit 150 is an example of an output means.

### Operation Example 1 of Monitoring Apparatus 100

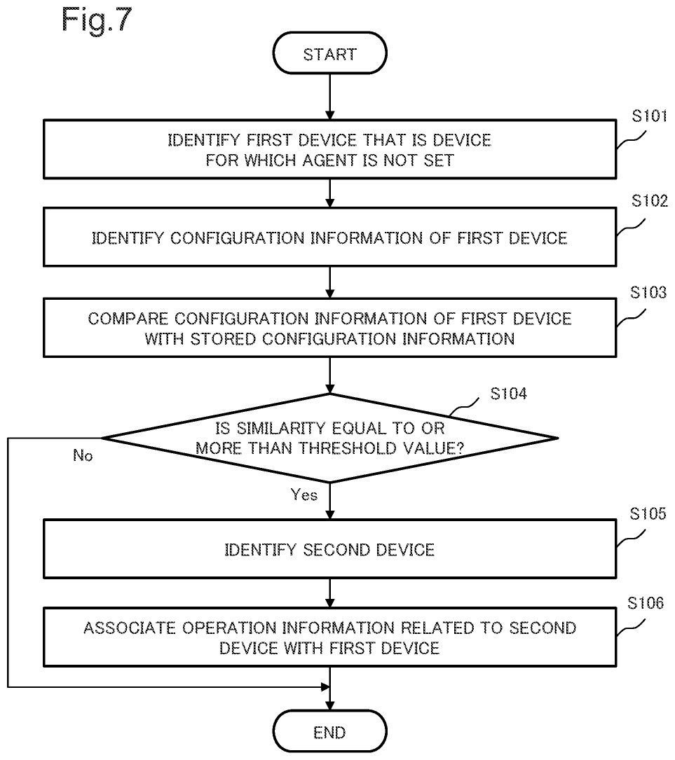

Next, an example of the operation of the monitoring apparatus 100 according to the second example embodiment will be described with reference to FIG. 7. FIG. 7 is a flowchart illustrating an example of the operation of the monitoring apparatus 100. More specifically, FIG. 7 illustrates an operation example when the monitoring apparatus 100 associates the first device with the operation information related to the second device. In the present operation example, it is assumed that the storage unit 110 stores the configuration information and the operation information related to each of the communication devices 200 in advance.

The first identification unit 120 identifies the first device that is a device for which an agent is not set (S101). Then, the first identification unit 120 identifies the configuration information of the identified first device from the configuration information stored in the storage unit 110 (S102). At this time, the first identification unit 120 may identify the configuration information relevant to the hardware and the configuration information relevant to the software related to the first device.

The second identification unit 130 compares the configuration information of the first device identified by the first identification unit 120 with each piece of the stored configuration information (S104). When there is the configuration information having a similarity equal to or more than a threshold value (“Yes” in S105), the second identification unit 130 identifies the device related to the configuration information having the similarity equal to or more than the threshold value as the second device (S105). The association unit 140 associates the operation information related to the second device with the first device (S106). In a case where there is no configuration information having the similarity equal to or more than the threshold value (“No” in S105), the monitoring apparatus 100 ends the processing.

### Operation Example 2 of Monitoring Apparatus 100

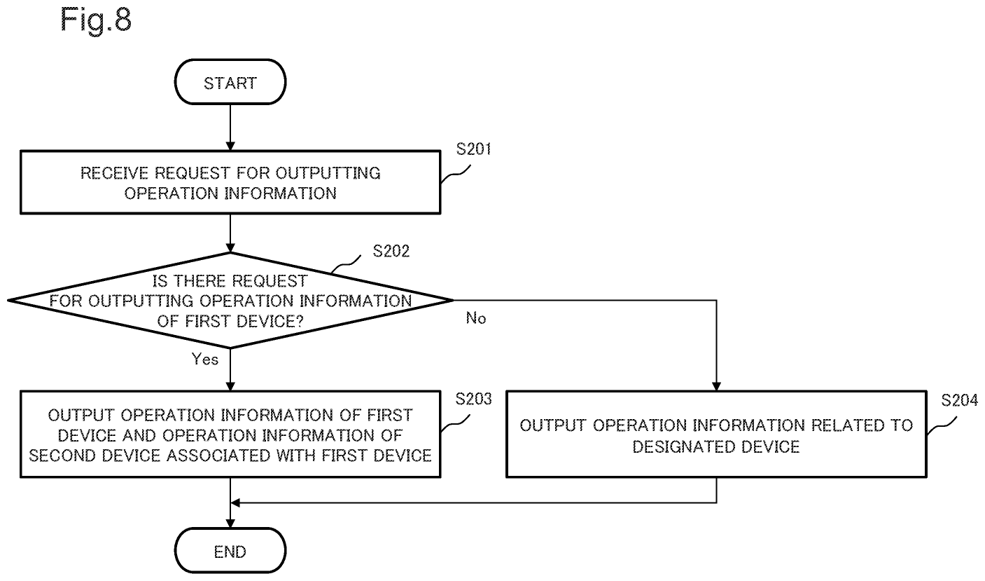

Next, an example of the operation of the monitoring apparatus 100 according to the second example embodiment will be described with reference to FIG. 8. FIG. 8 is a flowchart illustrating another example of the operation of the monitoring apparatus 100. More specifically, FIG. 8 illustrates an operation example when the monitoring apparatus 100 outputs information in response to a request. In the present operation example, it is assumed that the operation information of the second device is associated in advance with the first device.

The output unit 150 receives the request for outputting the operation information (S201). When the received request is the request for outputting the operation information of the first device (“Yes” in S202), the output unit 150 outputs the operation information of the first device and the operation information of the second device associated with the first device (S203).

When the received request is not the request for outputting the operation information of the first device (“No” in S202), the output unit 150 outputs the operation information related to the designated device (S204).

Each of Operation Examples 1 and 2 is merely an example, and the operation of the monitoring apparatus 100 is not limited to this example. For example, instead of the processing of S104 and S105, processing of identifying, as a second constituent element, a device related to configuration information common to the configuration information of the first device and the specific information may be performed.

As described above, the monitoring apparatus 100 according to the second example embodiment stores the configuration information related to each of the plurality of devices included in the system, and identifies the configuration information related to the first device for which the agent for collecting information is not set, among the plurality of devices. Then, the monitoring apparatus 100 identifies the second device, which is a device related to the configuration information similar to the configuration information related to the first device and for which the agent is set, among the plurality of devices, and associates the operation information of the second device including the information collected by the agent with the first device.

The device for which the agent is not set has less information that can be collected than the device for which the agent is set. On the other hand, the monitoring apparatus 100 may associate the operation information of the device having the similar configuration information, for which the agent is set, with the device for which the agent is not set. The devices with the similar configuration information may perform the same operation or cause similar anomalies. Therefore, the monitoring apparatus 100 may monitor even the device for which the agent is not set with reference to the similar operation information of the devices. As a result, the monitoring level for the first device can be substantially improved. That is, the monitoring apparatus 100 according to the second example embodiment is capable of assisting in monitoring the devices in the system that includes the devices for which the agent is not capable of being set.

The monitoring apparatus 100 according to the second example embodiment may identify the device related to the configuration information in which the similarity according to the number of items common to the configuration information related to the first device and the stored configuration information is equal to or more than the threshold value. As a result, the monitoring apparatus 100 may identify the second device similar to the first device.

In the second example embodiment, the stored configuration information includes the configuration information relevant to the hardware of each of the plurality of devices and the configuration information relevant to the software. The monitoring apparatus 100 identifies the configuration information relevant to the hardware related to the first device and the configuration information relevant to the software related to the first device. Then, the monitoring apparatus 100 identifies, as the second device, the device related to the configuration information similar to the configuration information relevant to the hardware related to the first device and the device related to the configuration information similar to the configuration information relevant to the software related to the first device. As a result, the monitoring apparatus 100 may appropriately identify the second device even in a case where a device having similar configuration information relevant to the hardware and a device having similar configuration information relevant to the software are different from each other.

In addition, the monitoring apparatus 100 of the second example embodiment associates the operation information relevant to the hardware of the second device similar to the configuration information relevant to the hardware related to the first device with the first device. Then, the monitoring apparatus 100 associates the operation information relevant to the software of the second device similar to the configuration information relevant to the software related to the first device with the first device, whereby the monitoring apparatus 100 may associate the appropriate operation information with the first device even in a case where the device having the similar configuration information relevant to the hardware and the device having the similar configuration information relevant to the software are different from each other.

When receiving the request for outputting the operation information of the first device, the monitoring apparatus 100 according to the second example embodiment outputs the operation information of the second device associated with the first device. As a result, the monitoring apparatus 100 may provide the user with the operation information of the second device as reference information of the first device. Therefore, the user can manage the first device based on the operation information.

### Modification Example 1

When there is a plurality of devices similar to the configuration information related to the first device, a plurality of second devices may be identified. For example, when there is a plurality of devices related to the configuration information similar to the configuration information relevant to the hardware of the first device, the second identification unit 130 identifies each of a plurality of devices mp as the second device. Then, the association unit 140 may associate the operation information of the plurality of second devices with the first device. For example, the association unit 140 associates each piece of operation information relevant to the hardware of the second device with the first device.

### Modification Example 2

In the above example embodiments, an example has been described in which, when the second device is identified, the configuration information of the first device is compared with the configuration information stored in the storage unit 110. When the vulnerability information in the software is included in the configuration information, the second device may be identified based on the vulnerability information.

For example, the second identification unit 130 compares the vulnerability information included in the configuration information of the first device with the vulnerability information included in the stored configuration information. Then, in a case where there is configuration information having vulnerability information in which the type and the number of vulnerabilities match at a predetermined rate or more, the second identification unit 130 identifies a device related to the configuration information as the second device.

As described above, a monitoring apparatus 101 may calculate a similarity between the vulnerability information included in the configuration information of the first device and the vulnerability information included in each of the stored configuration information pieces, and identify, as the second device, the device related to the configuration information of which the calculated similarity is equal to or more than the threshold value.

### Third Example Embodiment

Next, a monitoring apparatus according to a third example embodiment will be described. In the third example embodiment, an example of processing when an anomaly is detected in a case where the operation information of the second device is associated with the first device will be mainly described. Some descriptions overlapping with the first example embodiment and the second example embodiment will be omitted.

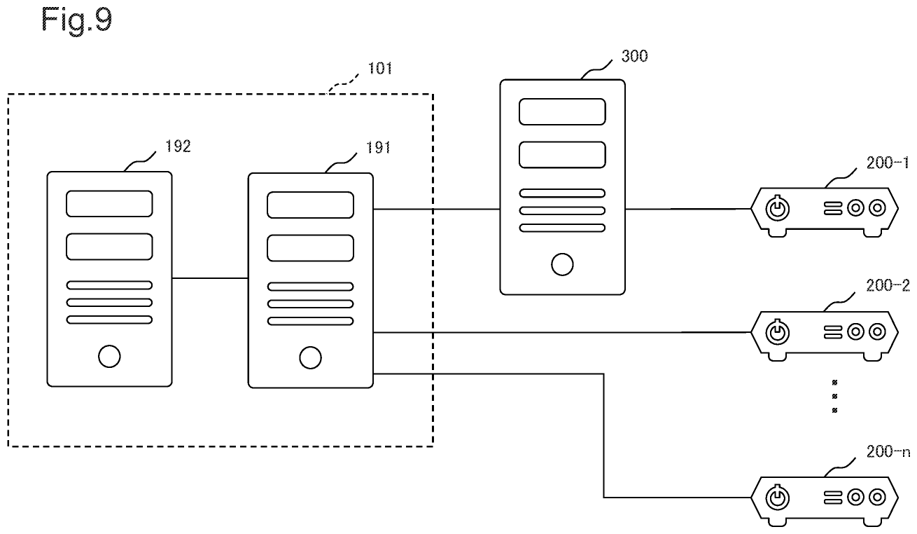

FIG. 9 is a diagram schematically illustrating an example of a configuration including the monitoring apparatus 101. As illustrated in FIG. 9, the monitoring apparatus 101 may include a shared server 191 and a countermeasure implementation server 192. The shared server 191 is connected to the countermeasure implementation server 192 and the communication device 200 such that communication is available. The shared server 191 is further connected to the terminal (not illustrated) of the user who manages the monitoring apparatus 101 such that communication is available.

Here, in the present example embodiment, it is also assumed that the communication device 200-1 is a device for which an agent is not set, and the communication devices 200-2, . . . , and 200-n are devices for which an agent is set. Then, it is assumed that the operation information of the communication device 200-2 is associated with the communication device 200-1.

### [Details of Monitoring Apparatus 101]

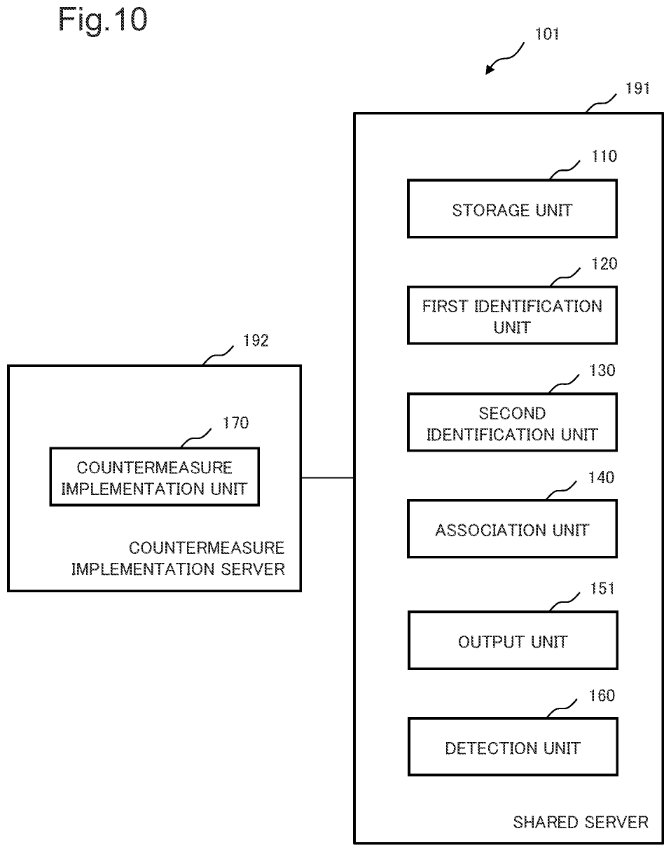

FIG. 10 is a block diagram illustrating an example of a functional configuration of the monitoring apparatus 101 according to the third example embodiment. As illustrated in FIG. 10, the shared server 191 includes the storage unit 110, the first identification unit 120, the second identification unit 130, the association unit 140, an output unit 151, and a detection unit 160. The countermeasure implementation server 192 includes a countermeasure implementation unit 170.

The detection unit 160 detects an anomaly. Specifically, the detection unit 160 detects an anomaly based on the information acquired from the communication device 200. For example, the detection unit 160 may detect a failure of the communication device 200 or detect an unauthorized access to the communication device 200, a cyberattack, or the like based on the operation information including the information collected by the agent. The detection unit 160 may detect the vulnerability by diagnosing the communication device 200 with the vulnerability. The operation information includes log information collected for each event that has occurred in the communication device 200. For example, the detection unit 160 acquires the log information at regular intervals, and determines whether the log information matches up with an anomaly abnormal model. For example, the detection unit 160 may detect an anomaly based on a result of the determination. The detection unit 160 may detect an anomaly using, for example, an intrusion detection system (IDS) or an intrusion prevention system (IPS). A method for detecting the anomaly is not limited to a specific method. The method for detecting the anomaly may be a method in which a device in which an anomaly has occurred and the type of anomaly are known. When detecting an anomaly, the detection unit 160 may generate information relevant to the anomaly. The information relevant to the anomaly includes information indicating the device in which an anomaly has occurred and the type of anomaly that has occurred. In this manner, the detection unit 160 detects an anomaly that has occurred in the device included in the system. The detection unit 160 is an example of a detection means.

The output unit 151 outputs an alert when an anomaly is detected by the detection unit 160. For example, the output unit 151 displays the information relevant to the anomaly as an alert on the display device. Here, in a case where the device in which an anomaly has occurred is the second device, the output unit 151 may also output information relevant to the first device associated with the operation information of the second device. For example, the output unit 151 outputs at least one of the information indicating the first device, the configuration information of the first device, and the operation information of the first device.

The countermeasure implementation unit 170 of the countermeasure implementation server 192 implements a countermeasure for the anomaly via the shared server 191. When an anomaly is detected by the detection unit 160, the countermeasure implementation unit 170 may implement a countermeasure for the device in which an anomaly has occurred. In addition, when the device in which an anomaly has occurred is the second device, the countermeasure implementation unit 170 may implement the countermeasure for the device (that is, the first device) associated with the operation information of the second device. The countermeasure implementation unit 170 may implement a countermeasure in response to an instruction from the user who operates the monitoring apparatus 101.

For example, in a case where an anomaly occurs in the communication device 200-2 and the vulnerability is detected, the countermeasure implementation unit 170 may stop a service relevant to the communication device 200-2. For example, when there is the vulnerability in the software of the communication device 200-2 and there is a modification program of the software, the countermeasure implementation unit 170 may apply the modification program and update the software. At this time, the countermeasure implementation unit 170 may similarly update the communication device 200-1 similar to the communication device 200-2. As described above, when the device in which an anomaly has occurred is the second device, the countermeasure implementation unit 170 may implement the countermeasure related to the anomaly on the first device. The countermeasure implementation unit 170 is an example of a countermeasure implementation means.

When the software is updated, the SW configuration information is changed. When the software is updated, the countermeasure implementation unit 170 may update the SW configuration information of the updated software, among the configuration information stored by the storage unit 110.

The countermeasure implementation unit 170 may implement a countermeasure in consideration of the influence on the system. For example, it is assumed that an anomaly is detected in the software of the communication device 200-2. As the countermeasure for the anomaly, when the software is updated, it is necessary to stop the service provided in the communication device 200-2. Such an influence on the system caused by implementing the countermeasure is also referred to as a side effect of the countermeasure.

Here, an anomaly similar to the anomaly that has occurred in the communication device 200-2 does not necessarily occur in the communication device 200-1. Therefore, there is a risk in implementing, on the communication device 200-1, a countermeasure with a severe side effect, such as stopping the service. Therefore, for example, the countermeasure implementation unit 170 may perform, with respect to the communication device 200-1, a countermeasure capable of continuing the service provided by the communication device 200-1. Specifically, for example, the countermeasure implementation unit 170 may temporarily stop the authority to change the setting of the system to an administrator of the system, or restrict the administrator from remotely connecting to the console of the system. The countermeasure capable of continuing the service may include a countermeasure for temporarily stopping the service. For example, the countermeasure capable of continuing the service includes a countermeasure that substantially has little influence on the provision of the service, such as stopping the service for 1 minute or stopping the service outside the service providing time. For example, the countermeasure implementation unit 170 may defer the countermeasure for the communication device 200-1. As described above, the countermeasure implementation unit 170 may implement, on the second constituent element, a countermeasure that is not required to stop the service relevant to the second constituent element.

### Operation Example of Monitoring Apparatus 101

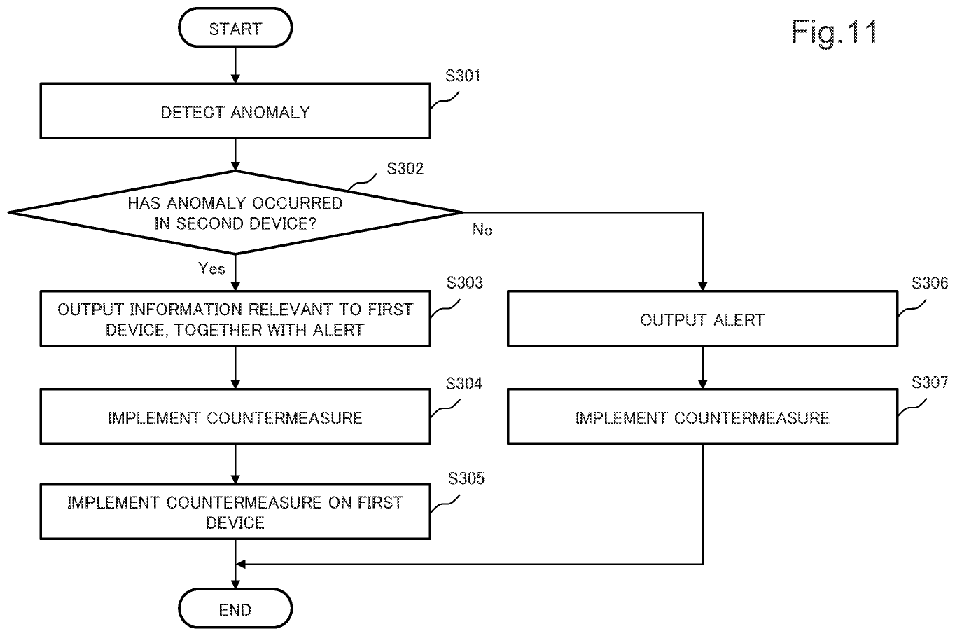

Next, an example of the operation of the monitoring apparatus 101 according to the third example embodiment will be described with reference to FIG. 11. FIG. 11 is a flowchart illustrating an example of the operation of the monitoring apparatus 101. More specifically, FIG. 11 illustrates an operation example when the monitoring apparatus 101 detects an anomaly. In the present operation example, it is assumed that the operation information of the second device is associated with the first device.

The detection unit 160 detects an anomaly (S301). When an anomaly has not occurred in the second device (“No” in S302), the output unit 151 outputs an alert (S306). Then, the countermeasure implementation unit 170 implements the countermeasure for the device in which an anomaly has occurred (S307).

When an anomaly has occurred in the second device (“Yes” in S302), the output unit 151 outputs the information relevant to the first device, together with the alert (S303). The countermeasure implementation unit 170 implements the countermeasure for the device in which an anomaly has occurred (S304). Then, the countermeasure implementation unit 170 implements a countermeasure for the detected anomaly on the first device (S305). At this time, in a case where a target in which an anomaly is detected is the second device, the output unit 151 outputs information relevant to the first device, together with the alert (S306).

This operation example is an example, and the operation of the monitoring apparatus 100 is not limited to this example.

As described above, the monitoring apparatus 101 according to the third example embodiment detects an anomaly that has occurred in the device included in the system, and outputs the information relevant to the first device when the device in which an anomaly is detected is the second device. When an anomaly occurs in the second device, a similar anomaly may occur in the first devices having similar configuration information. However, even in the case of the similar anomaly, there is a possibility that in the first device for which the agent is not set, the anomaly is not capable of being detected due to a lack of information to be collected. In contrast, the monitoring apparatus 101 may notify the user that there is a possibility that an anomaly similar to the anomaly that has occurred in the second device also occurs in the first device.

### Modification Example 3

In the above example embodiments, a configuration in which the monitoring apparatus 101 includes the shared server 191 and the countermeasure implementation server 192 has been described. The configuration of the monitoring apparatus 101 is not limited to this example. For example, the monitoring apparatus 101 may include one server. In this case, the storage unit 110, the first identification unit 120, the second identification unit 130, the association unit 140, the output unit 15, the detection unit 160, and the countermeasure implementation unit 170 may be enabled in one server. In addition, the monitoring apparatus 101 may include three or more servers. In this case, each of the storage unit 110, the first identification unit 120, the second identification unit 130, the association unit 140, the output unit 150, the detection unit 160, and the countermeasure implementation unit 170 may be enabled in any of the three or more servers.

### Modification Example 4

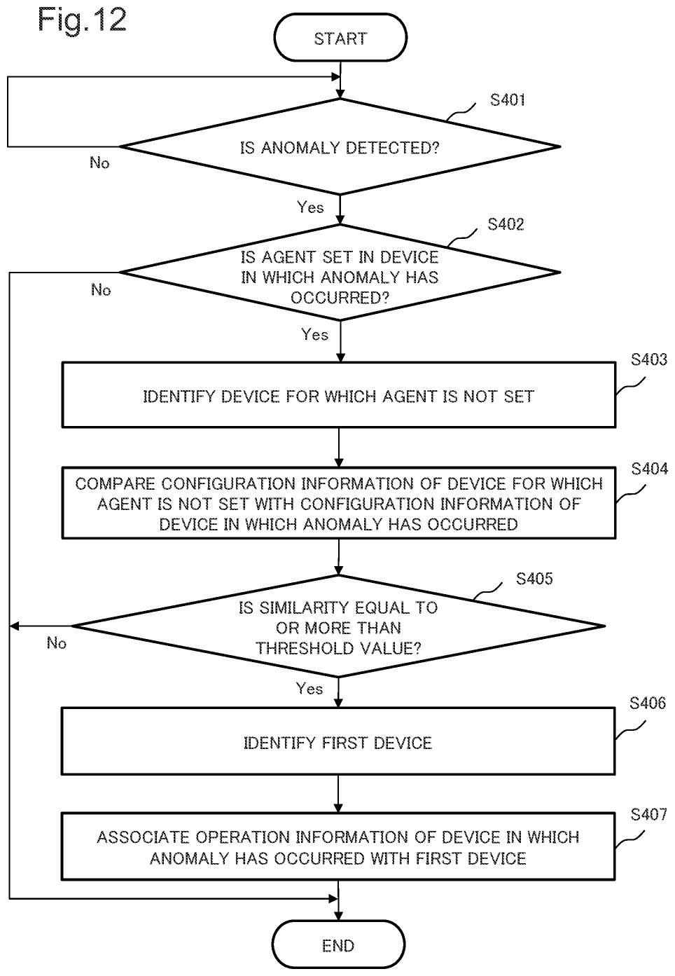

A timing when the processing of identifying the second device and associating the operation information related to the second device with the first device is performed is not limited to a specific timing. For example, each processing may be performed with the detection of an anomaly as a trigger. That is, the monitoring apparatus 101 may perform an operation example illustrated in FIG. 12 instead of the operation example illustrated in FIG. 7.

FIG. 12 is a flowchart illustrating an example of the operation of the monitoring apparatus 101 according to Modification Example 4. More specifically, FIG. 12 illustrates an example of the operation of the monitoring apparatus 101 when an anomaly is detected. When the detection unit 160 detects no anomaly (“No” in S401), the monitoring apparatus 101 ends the processing.

In a case where the detection unit 160 detects an anomaly (“Yes” in S401) and the device in which an anomaly has occurred is the device for which the agent is not set (“No” in S402), the monitoring apparatus 101 ends the processing.

When the detection unit 160 detects an anomaly (“Yes” in S401) and the device in which an anomaly has occurred is the device for which the agent is set (“Yes” in S402), the first identification unit 120 identifies the device for which the agent is not set (S403). Then, the first identification unit 120 compares the configuration information of the device for which the agent is not set with the configuration information of the device in which an anomaly has occurred (S404). When there is the device for which the agent is not set and which is related to the configuration information of which the similarity is equal to or more than the threshold value (“Yes” in S405), the first identification unit 120 identifies the device as the first device (S406). The association unit 140 associates the operation information of the device in which an anomaly has occurred with the first device (S407).

When there is no device for which the agent is not set and which is related to the configuration information of which the similarity is equal to or more than the threshold value (“No” in S405), the monitoring apparatus 101 ends the processing.

### Modification Example 5

In the above example embodiment, it has been described that, in a case where an anomaly is detected in the communication device 200-2, a countermeasure for a mild side effect may be performed with respect to the communication device 200-1, or a countermeasure for the communication device 200-1 may be deferred. On the other hand, in a case where the detected anomaly is an anomaly with a high degree of risk, it is preferable to implement a countermeasure on the communication device 200-1 in a preventive manner even in a case where the countermeasure has a severe side effect (that is, a countermeasure that greatly affects the provision of the service). Therefore, the monitoring apparatus 101 may calculate the priority of the countermeasure according to the degree of risk of the anomaly, and implement the countermeasure according to the priority.

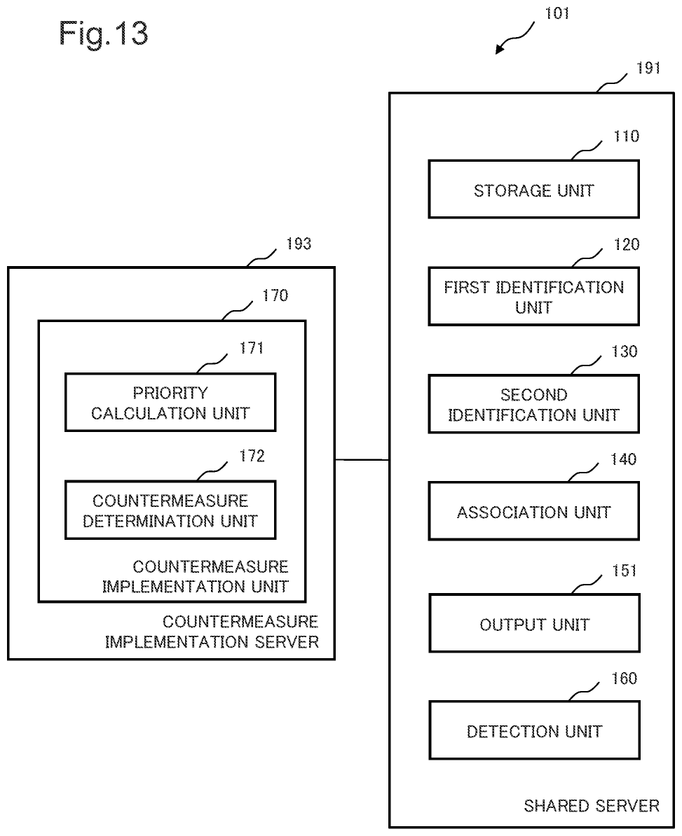

FIG. 13 is a block diagram illustrating an example of a functional configuration of the monitoring apparatus 101 according to Modification Example 5. As illustrated in FIG. 13, the countermeasure implementation unit 170 may include a priority calculation unit 171 and a countermeasure determination unit 172. The priority calculation unit 171 calculates the priority of the countermeasure related to the anomaly. Specifically, the priority calculation unit 171 generates the degree of risk of the detected anomaly. The degree of risk is an index relevant to the risk of the detected anomaly. For example, it is assumed that vulnerability is detected in the communication device 200-2. For example, the priority calculation unit 171 may generate the degree of risk according to the number of vulnerabilities. The priority calculation unit 171 may generate the degree of risk according to the type of influence considered when the vulnerability is attacked. The degree of risk may be, for example, a numerical value from 1 to 10, and the higher the numerical value, the higher the degree of risk. A method for generating the degree of risk is not limited to this example.

Then, the priority calculation unit 171 calculates the priority of the countermeasure to be implemented on the communication device 200-2 according to the degree of risk of the anomaly detected in the communication device 200-1. The priority is a numerical value from 1 to 3, and the lower the numerical value, the higher the priority. The expression of the priority is not limited thereto.

For example, it is assumed that vulnerability is detected in the communication device 200-2. At this time, a countermeasure A for applying the correction program for eliminating the vulnerability and updating the software and a countermeasure 2 for changing the authority to change the setting by the administrator are assumed in advance. The countermeasure A is a countermeasure (that is, a countermeasure that is highly effective but has a severe side effect) in which it is necessary to stop the service although it is possible to more reliably address the anomaly. The countermeasure 2 is a countermeasure (that is, a countermeasure that is less effective but has a mild side effect) in which it is not necessary to stop the service although it is unclear whether the anomaly can be reliably addressed.

For example, when the degree of risk of the detected anomaly is less than a threshold value, the priority calculation unit 171 sets the priority of the countermeasure A to 3 and the priority of the countermeasure 2 to 1. For example, in a case where the degree of risk of the detected anomaly is equal to or more than the threshold value, the priority calculation unit 171 sets the priority of the countermeasure A to 1 and sets the priority of the countermeasure 2 to 3.

In this manner, the priority calculation unit 171 calculates the priority of each of a plurality of countermeasures based on the degree of risk of the anomaly that has occurred in the second device and the influence of each of the plurality of countermeasures on the continuation of the service. The priority calculation unit 171 is an example of a priority calculation means.

The countermeasure determination unit 172 determines a countermeasure to be implemented according to the priority. For example, in the case of a countermeasure with the priority 1 and a countermeasure with the priority 3, the countermeasure determination unit 172 determines the countermeasure with the priority 1 as the countermeasure to be implemented. In this manner, the countermeasure determination unit 172 determines the countermeasure to be implemented on the first device according to the calculated priority. The countermeasure determination unit 172 is an example of a countermeasure determination means.

The output unit 151 may display information indicating the priority and the countermeasure on the display device included in the terminal. Then, the selection of the countermeasure by the administrator may be accepted in the terminal. In this case, the countermeasure determination unit 172 may determine the selected countermeasure as the countermeasure to be implemented.

As described above, the monitoring apparatus 101 of Modification Example 5 may implement the countermeasure in consideration of the degree of risk of the detected anomaly and the influence of the assumed countermeasure on the service.

### Configuration Example of Hardware of Monitoring Apparatus

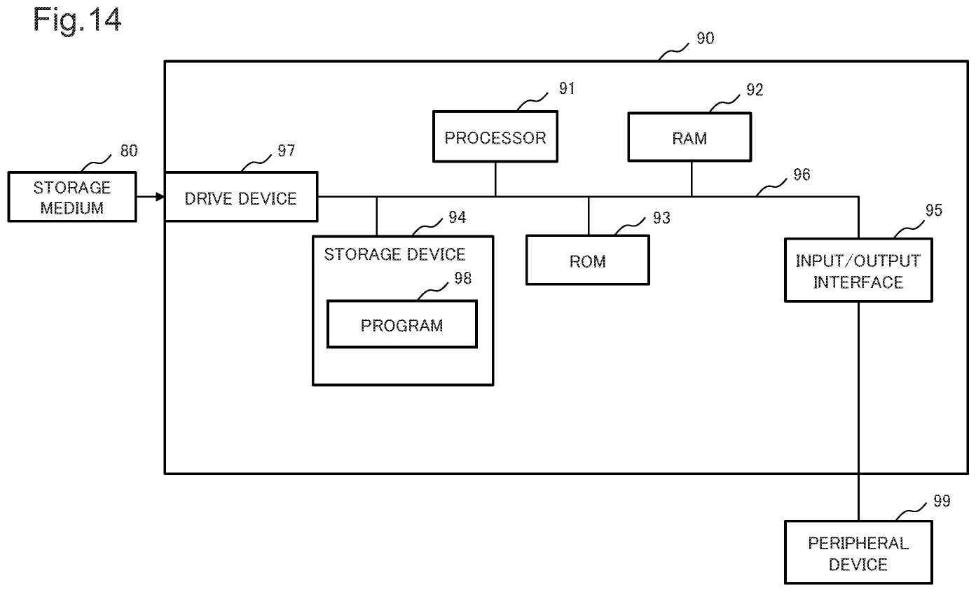

Hardware constituting the monitoring apparatus according to the first, second, and third example embodiments will be described. FIG. 14 is a block diagram illustrating an example of a configuration of a computer device that enables the monitoring apparatus according to each of the example embodiments. In a computer device 90, the monitoring apparatus and the monitoring method described in each of the example embodiments and each of the modification examples are enabled.

As illustrated in FIG. 14, the computer device 90 includes a processor 91, a random access memory (RAM) 92, a read only memory (ROM) 93, a storage device 94, an input/output interface 95, a bus 96, and a drive device 97. The monitoring apparatus may be enabled by a plurality of electric circuits.

The storage device 94 stores a program (computer program) 98. The processor 91 executes the program 98 of the monitoring apparatus using the RAM 92. Specifically, for example, the program 98 includes a program for allowing a computer to execute the processing illustrated in FIGS. 3, 7, 8, 11, and 12. When the processor 91 executes the program 98, the functions of each of the constituents of the monitoring apparatus are enabled. The program 98 may be stored in the ROM 93. The program 98 may be recorded in a storage medium 80 and read using the drive device 97, or may be transmitted from an external device (not illustrated) to the computer device 90 via a network (not illustrated).

The input/output interface 95 exchanges data with a peripheral device 99 (a keyboard, a mouse, a display device, and the like). The input/output interface 95 functions as a means that acquires or outputs data. The bus 96 connects the constituents to each other.

There are various modification examples of a method for enabling the monitoring apparatus. For example, the monitoring apparatus can be enabled as a dedicated device. The monitoring apparatus can be enabled based on a combination of a plurality of devices.

A processing method for recording, in a storage medium, a program for enabling each of the constituents in the functions of each of the example embodiments, reading the program recorded in the storage medium as a code, and executing the program in a computer is also included in the scope of each of the example embodiments. That is, a computer-readable storage medium is also included in the scope of each of the example embodiments. A storage medium in which the above-described program is recorded and the program itself is also included in each of the example embodiments.

The storage medium is, for example, a floppy (registered trademark) disk, a hard disk, an optical disk, a magneto-optical disk, a compact disc (CD)-ROM, a magnetic tape, a nonvolatile memory card, or a ROM, but is not limited to this example. The program recorded in the storage medium is not limited to a program that executes processing alone, and programs that are operated on an operating system (OS) to execute processing in cooperation with other software and the function of an extension board are also included in the scope of each of the example embodiments.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

The above-described example embodiments and modification examples can be appropriately combined.

The whole or part of the example embodiments disclosed above can be described as, but not limited to, the following supplementary notes.

### SUPPLEMENTARY NOTES

### Supplementary Note 1

A monitoring apparatus including:
a storage means configured to store configuration information related to each of a plurality of devices included in a system;
a first identification means configured to identify configuration information related to a first device for which an agent for collecting information is not set, among the plurality of devices;
a second identification means configured to identify a second device, which is a device related to configuration information similar to the configuration information related to the first device and for which the agent is set, among the plurality of devices; and
an association means configured to associate operation information of the second device, which includes information collected by the agent, with the first device.

### Supplementary Note 2

The monitoring apparatus according to supplementary note 1,
in which the second identification means identifies a device related to configuration information in which a similarity according to the number of items common to the configuration information related to the first device and the stored configuration information is equal to or more than a threshold value.

### Supplementary Note 3

The monitoring apparatus according to supplementary note 1 or 2,
in which the stored configuration information includes configuration information relevant to hardware of each of the plurality of devices and configuration information relevant to software,
the first identification means identifies configuration information relevant to hardware related to the first device and configuration information relevant to software related to the first device, and
the second identification means identifies, as the second device, a device related to configuration information similar to the configuration information relevant to the hardware related to the first device and a device related to configuration information similar to the configuration information relevant to the software related to the first device.

### Supplementary Note 4

The monitoring apparatus according to supplementary note 3,
in which the association means
associates operation information relevant to hardware of the second device similar to the configuration information relevant to the hardware related to the first device with the first device; and
associates operation information relevant to software of the second device similar to the configuration information relevant to the software related to the first device with the first device.

### Supplementary Note 5

The monitoring apparatus according to any one of supplementary notes 1 to 4, further including
an output means configured to output the operation information of the second device associated with the first device when receiving a request for outputting the operation information of the first device.

### Supplementary Note 6

The monitoring apparatus according to supplementary note 5, further including a detection means configured to detect an anomaly that has occurred in the device included in the system, in which the output means outputs information relevant to the first device when the device in which the anomaly has occurred is the second device.

### Supplementary Note 7

The monitoring apparatus according to supplementary note 6, further including
a countermeasure implementation means configured to implement, on the first device, a countermeasure related to an anomaly that has occurred in the second device.

### Supplementary Note 8

The monitoring apparatus according to supplementary note 7,
in which the countermeasure implementation means includes
a priority calculation means configured to calculate a priority of each of a plurality of countermeasures based on a degree of risk of the anomaly that has occurred in the second device and an influence of each of the plurality of countermeasures on continuation of a service, and
a countermeasure determination means configured to determine a countermeasure to be implemented on the first device according to the calculated priority.

### Supplementary Note 9

A monitoring method including:
storing configuration information related to each of a plurality of devices included in a system;
identifying configuration information related to a first device for which an agent for collecting information is not set, among the plurality of devices;
identifying a second device, which is a device related to configuration information similar to the configuration information related to the first device and for which the agent is set, among the plurality of devices; and
associating operation information of the second device, which includes information collected by the agent, with the first device.

### Supplementary Note 10

The monitoring method according to supplementary note 9, further including
identifying, in the identifying the second device, a device related to configuration information in which a similarity according to the number of items common to the configuration information related to the first device and the stored configuration information is equal to or more than a threshold value.

### Supplementary Note 11

The monitoring method according to supplementary note 9 or 10, further including:
including, in the stored configuration information, configuration information relevant to hardware of each of the plurality of devices and configuration information relevant to software;
identifying, in the identifying the configuration information, configuration information relevant to hardware related to the first device and configuration information relevant to software related to the first device are identified; and
identifying, in the identifying the second device, a device related to configuration information similar to the configuration information relevant to the hardware related to the first device and a device related to configuration information similar to the configuration information relevant to the software related to the first device are identified as the second device.

### Supplementary Note 12

The monitoring method according to supplementary note 11, further including:
in the associating,
associating operation information relevant to hardware of the second device similar to the configuration information relevant to the hardware related to the first device with the first device; and
associating operation information relevant to software of the second device similar to the configuration information relevant to the software related to the first device with the first device.

### Supplementary Note 13

The monitoring method according to any one of supplementary notes 9 to 12, further including outputting the operation information of the second device
associated with the first device when receiving a request for outputting the operation information of the first device.

### Supplementary Note 14

The monitoring method according to supplementary note 13, further including:
detecting an anomaly that has occurred in the device included in the system; and
outputting, in the outputting, information relevant to the first device when the device in which the anomaly has occurred is the second device.

### Supplementary Note 15

The monitoring method according to supplementary note 14, further including
implementing, on the first device, a countermeasure related to the anomaly that has occurred in the second device.

### Supplementary Note 16

The monitoring method according to supplementary note 15, further including:
in the implementing the countermeasure,
calculating a priority of each of a plurality of countermeasures based on a degree of risk of the anomaly that has occurred in the second device and an influence of each of the plurality of countermeasures on continuation of a service; and
determining a countermeasure to be implemented on the first device according to the calculated priority.

### Supplementary Note 17

A computer-readable storage medium storing a program for allowing a computer to execute:
processing of storing configuration information related to each of a plurality of devices included in a system;
processing of identifying configuration information related to a first device for which an agent for collecting information is not set, among the plurality of devices;
processing of identifying a second device, which is a device related to configuration information similar to the configuration information related to the first device and for which the agent is set, among the plurality of devices; and
processing of associating operation information of the second device, which includes information collected by the agent, with the first device.

### Supplementary Note 18

The computer-readable storage medium according to supplementary note 17,
in which in the processing of identifying the second device, a device related to configuration information in which a similarity according to the number of items common to the configuration information related to the first device and the stored configuration information is equal to or more than a threshold value is identified.

### Supplementary Note 19

The computer-readable storage medium according to supplementary note 17 or 18,
in which the stored configuration information includes configuration information relevant to hardware of each of the plurality of devices and configuration information relevant to software,
in the processing of identifying the configuration information, configuration information relevant to hardware related to the first device and configuration information relevant to software related to the first device are identified, and
in the processing of identifying the second device, a device related to configuration information similar to the configuration information relevant to the hardware related to the first device and a device related to configuration information similar to the configuration information relevant to the software related to the first device are identified as the second device.

### Supplementary Note 20

The computer-readable storage medium according to supplementary note 19,
in which in the processing of associating,
operation information relevant to hardware of the second device similar to the configuration information relevant to the hardware related to the first device is associated with the first device; and
operation information relevant to software of the second device similar to the configuration information relevant to the software related to the first device is associated with the first device.

### Supplementary Note 21

The computer-readable storage medium according to any one of supplementary notes 17 to 20, storing the program for allowing the computer to further execute
processing of outputting the operation information of the second device associated with the first device when receiving a request for outputting the operation information of the first device.

### Supplementary Note 22

The computer-readable storage medium according to supplementary note 21, storing the program for allowing the computer to further execute
processing of detecting an anomaly that has occurred in the device included in the system,
in which in the processing of outputting, information relevant to the first device is output when the device in which the anomaly has occurred is the second device.

### Supplementary Note 23

The computer-readable storage medium according to supplementary note 22, storing the program for allowing the computer to further execute
processing of implementing, on the first device, a countermeasure related to the anomaly that has occurred in the second device.

### Supplementary Note 24

The computer-readable storage medium according to supplementary note 23,
in which in the processing of implementing the countermeasure,
a priority of each of a plurality of countermeasures is calculated based on a degree of risk of the anomaly that has occurred in the second device and an influence of each of the plurality of countermeasures on continuation of a service, and
a countermeasure to be implemented on the first device is determined according to the calculated priority.

### REFERENCE SIGNS LIST

100, 101, 102 monitoring apparatus
110 storage unit
120 first identification unit
130 second identification unit
140 association unit
150, 151 output unit
160 detection unit
170 countermeasure implementation unit
180 priority calculation unit
191 shared server
192, 193 countermeasure implementation server
200 communication device

What is claimed is:

1. A monitoring apparatus comprising:
a memory storing instructions; and
at least one processor configured to execute the instructions to:
to store configuration information related to each of a plurality of devices included in a system;
identify configuration information related to a first device for which an agent for collecting information is not set, among the plurality of devices;
identify a second device, which is a device related to configuration information similar to the configuration information related to the first device and for which the agent is set, among the plurality of devices; and
associate operation information of the second device, which includes information collected by the agent, with the first device.

2. The monitoring apparatus according to claim 1, wherein
the at least one processor is further configured to execute the instructions to:
identify a device related to configuration information in which a similarity according to the number of items common to the configuration information related to the first device and the stored configuration information is equal to or more than a threshold value.

3. The monitoring apparatus according to claim 1, wherein
the stored configuration information includes configuration information relevant to hardware of each of the plurality of devices and configuration information relevant to software, and
the at least one processor is further configured to execute the instructions to:
identify configuration information relevant to hardware related to the first device and configuration information relevant to software related to the first device; and
identify, as the second device, a device related to configuration information similar to the configuration information relevant to the hardware related to the first device and a device related to configuration information similar to the configuration information relevant to the software related to the first device.

4. The monitoring apparatus according to claim 3, wherein
the at least one processor is further configured to execute the instructions to:
associate operation information relevant to hardware of the second device similar to the configuration information relevant to the hardware related to the first device with the first device; and
associate operation information relevant to software of the second device similar to the configuration information relevant to the software related to the first device with the first device.

5. The monitoring apparatus according to claim 1, wherein
the at least one processor is further configured to execute the instructions to:
output the operation information of the second device associated with the first device when receiving a request for outputting the operation information of the first device.

6. The monitoring apparatus according to claim 5, wherein
the at least one processor is further configured to execute the instructions to:
detect an anomaly that has occurred in the device included in the system; and
output information relevant to the first device when the device in which the anomaly has occurred is the second device.

7. The monitoring apparatus according to claim 6, wherein
the at least one processor is further configured to execute the instructions to:
implement, on the first device, a countermeasure related to an anomaly that has occurred in the second device.

8. The monitoring apparatus according to claim 7, wherein
the at least one processor is further configured to execute the instructions to:
calculate a priority of each of a plurality of countermeasures based on a degree of risk of the anomaly that has occurred in the second device and an influence of each of the plurality of countermeasures on continuation of a service; and
determine a countermeasure to be implemented on the first device according to the calculated priority.

9. A monitoring method comprising:
storing configuration information related to each of a plurality of devices included in a system;
identifying configuration information related to a first device for which an agent for collecting information is not set, among the plurality of devices;
identifying a second device, which is a device related to configuration information similar to the configuration information related to the first device and for which the agent is set, among the plurality of devices; and
associating operation information of the second device, which includes information collected by the agent, with the first device.

10. The monitoring method according to claim 9, further comprising
identifying, in the identifying the second device, a device related to configuration information in which a similarity according to the number of items common to the configuration information related to the first device and the stored configuration information is equal to or more than a threshold value.

11. The monitoring method according to claim 9, further comprising:
including, in the stored configuration information, configuration information relevant to hardware of each of the plurality of devices and configuration information relevant to software;
identifying, in the identifying the configuration information, configuration information relevant to hardware related to the first device and configuration information relevant to software related to the first device; and
identifying, in the identifying the second device, a device related to configuration information similar to the configuration information relevant to the hardware related to the first device and a device related to configuration information similar to the configuration information relevant to the software related to the first device as the second device.

12. The monitoring method according to claim 11, further comprising:
in the associating,
associating operation information relevant to hardware of the second device similar to the configuration information relevant to the hardware related to the first device with the first device; and
associating operation information relevant to software of the second device similar to the configuration information relevant to the software related to the first device with the first device.

13. The monitoring method according to claim 9, further comprising
outputting the operation information of the second device associated with the first device when receiving a request for outputting the operation information of the first device.

14. The monitoring method according to claim 13, further comprising:
detecting an anomaly that has occurred in the device included in the system; and
outputting, in the outputting, information relevant to the first device when the device in which the anomaly has occurred is the second device.

15. The monitoring method according to claim 14, further comprising
implementing, on the first device, a countermeasure related to the anomaly that has occurred in the second device.

16. The monitoring method according to claim 15, further comprising:
in the implementing the countermeasure,
calculating a priority of each of a plurality of countermeasures based on a degree of risk of the anomaly that has occurred in the second device and an influence of each of the plurality of countermeasures on continuation of a service; and
determining a countermeasure to be implemented on the first device according to the calculated priority.

17. A computer-readable storage medium non-transitorily storing a program for allowing a computer to execute:
processing of storing configuration information related to each of a plurality of devices included in a system;
processing of identifying configuration information related to a first device for which an agent for collecting information is not set, among the plurality of devices;
processing of identifying a second device, which is a device related to configuration information similar to the configuration information related to the first device and for which the agent is set, among the plurality of devices; and
processing of associating operation information of the second device, which includes information collected by the agent, with the first device.

18. The computer-readable storage medium according to claim 17,
wherein in the processing of identifying the second device, a device related to configuration information in which a similarity according to the number of items common to the configuration information related to the first device and the stored configuration information is equal to or more than a threshold value is identified.

19. The computer-readable storage medium according to claim 17,
wherein the stored configuration information includes configuration information relevant to hardware of each of the plurality of devices and configuration information relevant to software,
in the processing of identifying the configuration information, configuration information relevant to hardware related to the first device and configuration information relevant to software related to the first device are identified, and
in the processing of identifying the second device, a device related to configuration information similar to the configuration information relevant to the hardware related to the first device and a device related to configuration information similar to the configuration information relevant to the software related to the first device are identified as the second device.

20. The computer-readable storage medium according to claim 19,
wherein in the processing of associating,
operation information relevant to hardware of the second device similar to the configuration information relevant to the hardware related to the first device is associated with the first device; and
operation information relevant to software of the second device similar to the configuration information relevant to the software related to the first device is associated with the first device.

21. The computer-readable storage medium according to claim 17, storing the program for allowing the computer to further execute
processing of outputting the operation information of the second device associated with the first device when receiving a request for outputting the operation information of the first device.

22. The computer-readable storage medium according to claim 21, storing the program for allowing the computer to further execute
processing of detecting an anomaly that has occurred in the device included in the system,
wherein in the processing of outputting, information relevant to the first device is output when the device in which the anomaly has occurred is the second device.

23. The computer-readable storage medium according to claim 22, storing the program for allowing the computer to further execute
processing of implementing, on the first device, a countermeasure related to the anomaly that has occurred in the second device.

24. The computer-readable storage medium according to claim 23,
wherein in the processing of implementing the countermeasure,
a priority of each of a plurality of countermeasures is calculated based on a degree of risk of the anomaly that has occurred in the second device and an influence of each of the plurality of countermeasures on continuation of a service, and
a countermeasure to be implemented on the first device is determined according to the calculated priority.
